(19) United States
(12) Patent Application Publication
(10) Pub. No.: US 2025/0157692 A1
(43) Pub. Date: May 15, 2025

(54) WIRE HARNESS

(71) Applicant: YAZAKI CORPORATION, Tokyo (JP)

(72) Inventors: Mitsuhisa Sano, Makinohara-shi (JP); Taku Furuta, Makinohara-shi (JP); Kenichi Imou, Makinohara-shi (JP); Junya Kato, Makinohara-shi (JP); Hiroki Suganuma, Makinohara-shi (JP)

(21) Appl. No.: 18/940,711

(22) Filed: Nov. 7, 2024

(30) Foreign Application Priority Data
Nov. 14, 2023 (JP) 2023-193996

(51) Int. Cl. H01B 7/40; B60R 16/02; H01B 7/00

(52) U.S. Cl. CPC H01B 7/40; B60R 16/0207; H01B 7/0045

(57) ABSTRACT

A wire harness includes a flat wiring member having flexibility, a first connector provided at an end portion of the flat wiring member and connected to a first connection target, and a second connector provided on a surface of the flat wiring member and connected to a second connection target. Further, the flat wiring member includes an attachment hole portion formed at a position neighboring the second connector, into which an attachment projection portion provided on an attachment target portion is to be inserted, and an inner diameter of the attachment hole portion is set to a diameter larger than an outer diameter of the attachment projection portion 110.

### CROSS-REFERENCE TO RELATED APPLICATION(S)

The present application claims priority to and incorporates by reference the entire contents of Japanese Patent Application No. 2023-193996 filed in Japan on Nov. 14, 2023.

### BACKGROUND OF THE INVENTION

### 1. Field of the Invention

The present invention relates to a wire harness.

### 2. Description of the Related Art

For example, Japanese Patent Application Laid-open No. 2019-137394 discloses a wiring structure of a wire harness in which a wire harness and an auxiliary machine are electrically connected.

On the other hand, when a wire harness (wiring member) and an auxiliary machine are electrically connected as in the wiring structure of the wire harness described in Japanese Patent Application Laid-open No. 2019-137394 mentioned above, if the auxiliary machine is fitted with a connector provided on the wiring member, there is concern that the auxiliary machine fails to be appropriately connected to the connector due to an attachment tolerance or the like of the auxiliary machine with respect to an attachment target portion. Therefore, there is room for further improvement in terms of ease of assembly.

### SUMMARY OF THE INVENTION

The present invention has been devised in view of the above-described circumstances, and the object of the present invention is to provide a wire harness that can enhance ease of assembly.

In order to achieve the above object, a wire harness according to one aspect of the invention includes a flat wiring member having flexibility; a first connector provided at an end portion of the flat wiring member and connected to a first connection target; and a second connector provided on a surface of the flat wiring member and connected to a second connection target, wherein the flat wiring member includes an attachment hole portion formed at a position neighboring the second connector, into which an attachment projection portion provided on an attachment target portion is to be inserted, and an inner diameter of the attachment hole portion is set to a diameter larger than an outer diameter of the attachment projection portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a schematic configuration of a wire harness according to the present embodiment;

FIG. 2 is an exemplary cross-sectional view illustrating a connection structure of a second connector of the wire harness and a second connection target according to the present embodiment;

FIG. 3 is a cross-sectional view illustrating assembly of the wire harness according to the present embodiment;

FIG. 4 is a cross-sectional view illustrating assembly of the wire harness according to the present embodiment;

FIG. 5 is a cross-sectional view illustrating assembly of the wire harness according to the present embodiment;

FIG. 6 is a cross-sectional view illustrating assembly of the wire harness according to the present embodiment; and

FIG. 7 is a cross-sectional view illustrating assembly of the wire harness according to the present embodiment.

### DETAILED DESCRIPTION OF THE PREFERRED EMBODIMENTS

An embodiment according to the present invention will be described in detail below based on the drawings. In addition, the present invention is not limited by the embodiment. Further, components in the following embodiment include the ones that can be replaced by those skilled in the art, and are easy, or the ones that are substantially identical.

### Embodiment

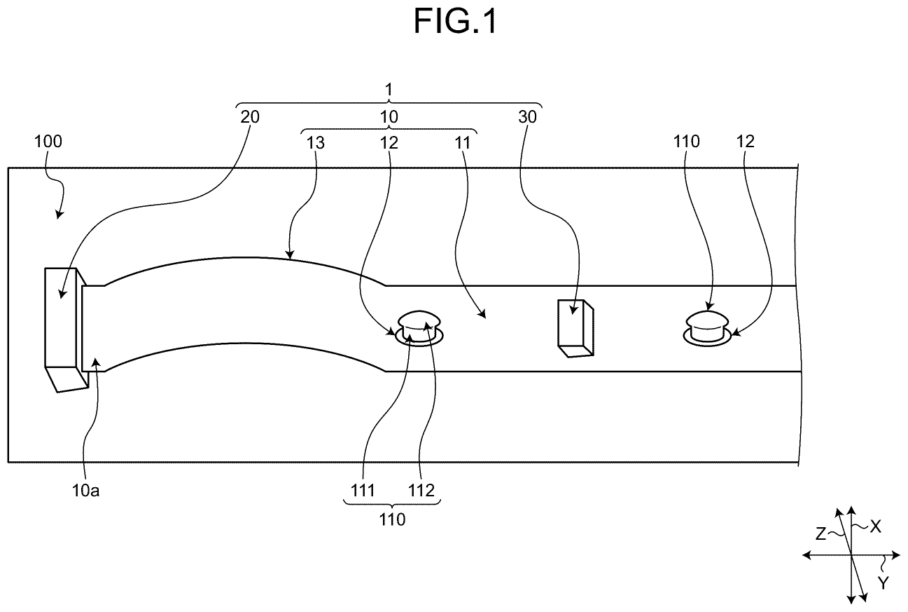

A wire harness 1 illustrated in FIG. 1 is applied to a vehicle, and used for power supply and signal communication by connecting devices mounted on the vehicle. In the wire harness 1 of the present embodiment, a flat wiring member 10 having flexibility is applied as a wiring member, and the flat wiring member 10 is wired to an attachment target portion 100 constituting at least a part of a vehicle body panel. Then, the wire harness 1 realizes a configuration that can enhance ease of assembly, by forming an attachment hole portion 12 provided in the flat wiring member 10, in a size larger than that of an attachment projection portion 110 provided in the attachment target portion 100. Hereinafter, the configuration of the wire harness 1 will be described in detail with reference to FIGS. 1 to 7.

In addition, the vehicle body panel here refers to a structure member (framework member) of the vehicle, and for example, is a member such as a dash panel, a door panel, or a roof panel.

Further, in the following description, among a first direction, a second direction, and a third direction that intersect with each other, the first direction will be referred to as a “length direction X”, the second direction will be referred to as a “width direction Y”, and the third direction will be referred to as a “thickness direction Z)”. Here, the length direction X, the width direction Y, and the thickness direction Z are orthogonal to each other. Further, the length direction X typically corresponds to a longer direction (extending direction) of the flat wiring member 10, and the width direction Y typically corresponds to a shorter direction of the flat wiring member 10. Further, XY directions illustrated in FIGS. 1 to 7 correspond to a planar direction of the flat wiring member 10. In addition, each direction to be used in the following description will be described as a direction set in a state in which the wire harness 1 is attached to the attachment target portion 100, unless otherwise stated.

As illustrated in FIG. 1, the wire harness 1 includes the flat wiring member 10 having flexibility, a first connector 20 provided at an end portion 10a of the flat wiring member 10, and a second connector 30 provided on a surface 11 of the flat wiring member 10.

The flat wiring member 10 is a wiring member constituting the wire harness 1. The flat wiring member 10 of the present embodiment is a flexible printed circuit (FPC). Further, the flat wiring member 10 includes a base film, a wiring pattern, and a coverlay. In addition, the base film here is a base material that has good flexibility, and defines an overall shape of the flat wiring member 10. The base film is formed of polyimide resin with good heat resistance or the like, For example. Further, the wiring pattern is stacked on the surface of the base film, for example, and forms a plurality of conductor circuit portions (pattern layers). The wiring pattern is formed of conductive metal material such as copper foil, for example, and is printed on the surface of the base film as a printed circuit member. Further, the coverlay is stacked over the entire surface of the base film via an adhesive agent (not illustrated), and functions as a protective layer that protects the conductor circuit portions or the like of the wiring pattern.

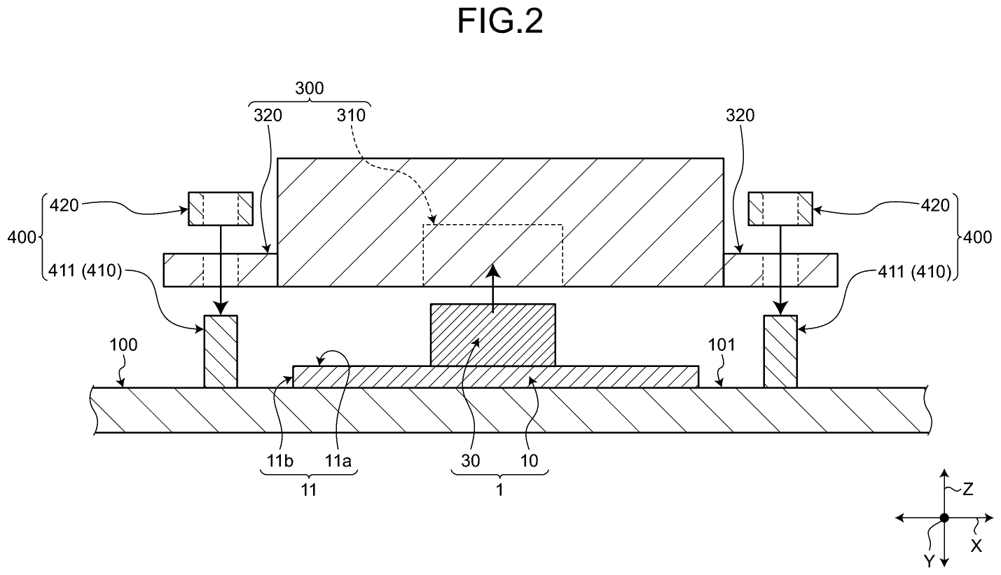

Further, as illustrated in FIG. 1, the flat wiring member 10 is formed into a thin plate shape, extends along the length direction X and the width direction Y, and is formed into an approximately-rectangular shape with the thickness direction Z corresponding to a plate thickness direction. In addition, the flat wiring member 10 of the present embodiment includes a principal surface 11a formed along the length direction X and the width direction Y, and formed as a surface with an area larger than other surfaces, and an end surface 11b formed along the thickness direction Z orthogonal to the principal surface 11a, and formed as a surface with an area smaller than the surface. Then, in the flat wiring member 10 of the present embodiment, the second connector 30 is provided on the surface 11 being the principal surface 11a among the surfaces 11 of the flat wiring member 10 (refer to FIG. 2).

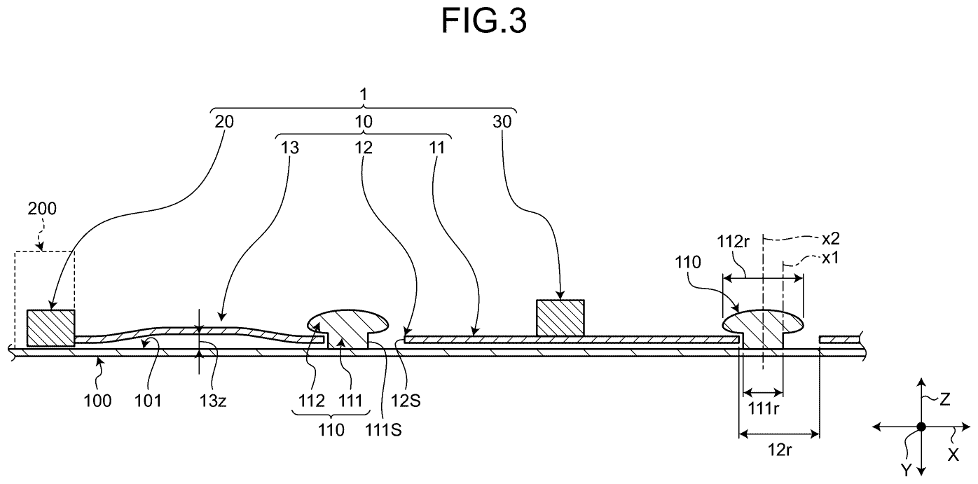

A pair of first connectors 20 is provided at an interval, and corresponds to connection parts provided at both end portions 10a in the length direction X of the flat wiring member 10. The first connector 20 is electrically connected with the conductor circuit portion (pattern layer) of the flat wiring member 10. Further, by being connected to a first connection target 200 (refer to FIGS. 3 to 5) preliminarily fixed to the attachment target portion 100, the first connector 20 can electrically connect the flat wiring member 10 and the first connection target 200.

The first connection target 200 is a control device (electronic control unit (ECU)), for example, and the device is provided with a first connection target side connector that can fit with the first connector 20. Thus, by fitting with the first connection target side connector with a fitting direction being set to a direction intersecting with the thickness direction Z of the flat wiring member 10 (in the present embodiment, the length direction X of the flat wiring member 10), the first connector 20 electrically connects the first connection target 200 and the flat wiring member 10. Further, by the pair of first connectors 20 fitting with the respective first connection target side connectors, the flat wiring member 10 can electrically connect control devices. In addition, the first connection target 200 may be a device other than the ECU, and various changes can be made in accordance with the specification of the wire harness 1.

At least one second connector 30 is provided, and is a connection part provided between the pair of first connectors 20. The second connector 30 is electrically connected with the conductor circuit portion (pattern layer) of the flat wiring member 10. Further, by being connected to a second connection target 300 (refer to FIGS. 3 to 5) when the second connection target 300 is fixed to the attachment target portion 100, the first connector 20 can electrically connect the flat wiring member 10 and the second connection target 300.

The second connection target 300 is an auxiliary device (auxiliary machine) to be used to operate a main device, for example, and is a control device (ECU) in the present embodiment. Then, as illustrated in FIG. 2, the device is provided with a second connection target side connector 310 that can fit with the second connector 30. Thus, by fitting with the second connection target side connector 310 with the fitting direction being set to the thickness direction Z of the flat wiring member 10, the second connector 30 electrically connects the second connection target 300 and the flat wiring member 10. Then, by being fastened by a fastening member 400 in a state of being connected with the flat wiring member 10, the second connection target 300 is fixed to the attachment target portion 100.

Specifically, as illustrated in FIG. 2, in the fastening member 400 of the present embodiment includes a bolt 410 and a nut 420. Further, the auxiliary machine being the second connection target 300 is provided with a flange 320 including a through-hole into which the bolt 410 is to be inserted, the through-hole being formed along the thickness direction Z of the flat wiring member 10. At this time, for example, a head portion (not illustrated) of the bolt 410 is engaged with the attachment target portion 100, and a shaft portion 411 extending from the head portion is attached in a state of penetrating through the attachment target portion 100 and the flange 320. Then, the bolt 410 protrudes from the attachment target portion 100 side toward the second connection target 300 side, and is fastened with the nut 420 in a state of being inserted into the through-hole formed in the flange 320 of the second connection target 300.

Further, the flat wiring member 10 having the above-described configuration further includes the attachment hole portion 12 and a looseness forming portion 13. Then, the flat wiring member 10 is attached to the attachment target portion 100 by the attachment projection portion 110 provided on the attachment target portion 100, being inserted into the attachment hole portion 12.

Here, the structure of the attachment projection portion 110 will be described.

The attachment projection portion 110 is a boss formed on the attachment target portion 100. As illustrated in FIG. 1, the attachment projection portion 110 of the present embodiment includes a shaft portion 111 and an engagement lug portion 112.

The shaft portion 111 is a small diameter portion formed on the proximal end side of the attachment projection portion 110. The shaft portion 111 of the present embodiment is formed into a columnar shape. Further, the shaft portion 111 is formed with protruding from a surface 101 (refer to FIGS. 2 to 5) of in the attachment target portion 100 on which the flat wiring member 10 is wired, in a direction orthogonal to the surface 101 (the thickness direction Z of the flat wiring member 10).

The engagement lug portion 112 is a large diameter portion formed with protruding from the shaft portion 111, and formed at the leading end side of the attachment projection portion 110. The engagement lug portion 112 of the present embodiment is formed into a columnar shape. Further, the size of the engagement lug portion 112 (an outer diameter 112r of the engagement lug portion 112 illustrated in FIG. 3) is set to a size larger than the size of the shaft portion 111 (an outer diameter 111r of the shaft portion 111 illustrated in FIG. 3).

Further, the structures of the attachment hole portion 12 into which the attachment projection portion 110 having the above-described configuration is to be inserted, and the looseness forming portion 13 will be described.

The attachment hole portion 12 is a through-hole formed along the thickness direction Z of the flat wiring member 10. As illustrated in FIG. 1, a pair of attachment hole portions 12 is formed into an approximately circular shape, and provided at an interval. Further, the attachment hole portions 12 are provided at an interval along the length direction X of the flat wiring member 10, and formed at positions neighboring the second connector 30. Further, one attachment hole portion 12 is provided between the first connector 20 provided at the end portion 10a of the flat wiring member 10, and the second connector 30, and the other attachment hole portion 12 is provided at a position on the opposite side of the one attachment hole portion 12 across the second connector 30. Thus, as illustrated in FIG. 1, the second connector 30 is provided between the pair of attachment hole portions 12.

Further, the size of the attachment hole portion 12 (an inner diameter 12r of the attachment hole portion 12 illustrated in FIG. 3) is set to a size larger than the size of the shaft portion 111 (the outer diameter 111r of the shaft portion 111 illustrated in FIG. 3). Thus, a clearance gap is formed between the attachment hole portion 12 of the present embodiment and the shaft portion 111 located inside in a state in which the shaft portion 111 is inserted.

Further, the attachment hole portion 12 is formed in a size into which the engagement lug portion 112 can be inserted. Thus, by the engagement lug portion 112 being inserted into the attachment hole portion 12, and the attachment hole portion 12 being further pushed in toward the attachment target portion 100 side, when the flat wiring member 10 of the present embodiment is attached to the attachment target portion 100 (wired to the attachment target portion 100), the shaft portion 111 is inserted into the attachment hole portion 12. Then, if the attachment projection portion 110 is inserted into the attachment hole portion 12, by a rim portion forming the attachment hole portion 12, getting caught on the engagement lug portion 112 formed on the leading end side of the attachment projection portion 110, the flat wiring member 10 is engaged with the attachment projection portion 110. In addition, the size of the engagement lug portion 112 is not specifically limited as long as the engagement lug portion 112 has a size that enables the engagement lug portion 112 to be inserted into the attachment hole portion 12 of the flat wiring member 10. For example, similarly to the shaft portion 111, the size of the engagement lug portion 112 may be set to a size smaller than the size of the attachment projection portion 110. Further, the engagement lug portion 112 may be formed in a size equal to or larger than the size of the attachment projection portion 110, and the size of the engagement lug portion 112 may be set to a size that enables the engagement lug portion 112 to be inserted into the attachment hole portion 12 by warping the flat wiring member 10 side.

Further, the attachment hole portion 12 is formed into a size that enables relative movement along the planar direction of the flat wiring member within a range within which an inner circumferential surface 12S of the attachment hole portion 12 and an outer circumferential surface 111S of the shaft portion 111 formed on the proximal end side of the attachment projection portion 110 have contact. Thus, when relatively moving along the planar direction, the flat wiring member 10 can relatively move the second connector 30 provided on the surface 11 of the flat wiring member 10, together with the flat wiring member.

The looseness forming portion 13 is an extra length portion formed in one section of the flat wiring member 10 in a state in which the flat wiring member 10 is attached to the attachment target portion 100. As illustrated in FIG. 1, the looseness forming portion 13 of the present embodiment is formed over a space between the first connector 20 provided at the end portion 10a of the flat wiring member 10, and the attachment hole portion 12 provided on the surface 11 of the flat wiring member 10. Further, the looseness forming portion 13 is formed by a length from the first connector 20 to the attachment hole portion 12 being set to a length longer than a length to the attachment projection portion 110 from a fixed position of the first connector 20 in the first connection target 200 fixed to the attachment target portion 100 (position of the first connection target side connector). Accordingly, the length of the looseness forming portion 13 is set to a length that enables an extra length (looseness) to be formed between the first connector 20 and the attachment hole portion 12 in a state in which the first connector 20 is connected to the first connection target 200, and the attachment projection portion 110 is inserted into the attachment hole portion 12. Thus, the flat wiring member 10 is attached to the attachment target portion 100 in a state in which a section from the first connector 20 to the attachment hole portion 12 warps.

Next, an assembling operation of the wire harness 1 will be described with reference to FIGS. 3 to 7.

First of all, as illustrated in FIG. 3, an operator connects the first connector 20 provided at the end portion 10a of the flat wiring member 10, to the first connection target 200 preliminarily fixed to the attachment target portion 100. Then, the operator inserts the shaft portion 111 of the attachment projection portion 110 of the attachment target portion 100 into the attachment hole portion 12 of the flat wiring member 10 by further pushing in the flat wiring member 10 toward the attachment target portion 100 side in a state in which the engagement lug portion 112 of the attachment projection portion 110 of the attachment target portion 100 is inserted in the attachment hole portion 12 formed in the flat wiring member 10.

Next, the operator adjusts the position of the second connector 30 provided on the surface 11 of the flat wiring member 10. In the flat wiring member 10 of the present embodiment, the inner diameter 12r of the attachment hole portion 12 is set to a diameter larger than the outer diameter of the attachment projection portion 110. Thus, the flat wiring member 10 can relatively move in the planar direction (the XY direction illustrated in FIG. 3, and a direction running along the planar direction of the attachment target portion 100) within the range within which the inner circumferential surface 12S of the attachment hole portion 12 and the outer circumferential surface 111S of the shaft portion 111 formed on the proximal end side of the attachment projection portion 110 have contact. Further, because the looseness forming portion 13 is formed between the first connector 20 and the attachment hole portion 12, the flat wiring member 10 can extend and contract the looseness forming portion 13 in accordance with the relative movement along the planar direction. Thus, the flat wiring member 10 can prevent the relative movement from being disturbed, by causing the looseness forming portion 13 to absorb a displacement caused by the relative movement.

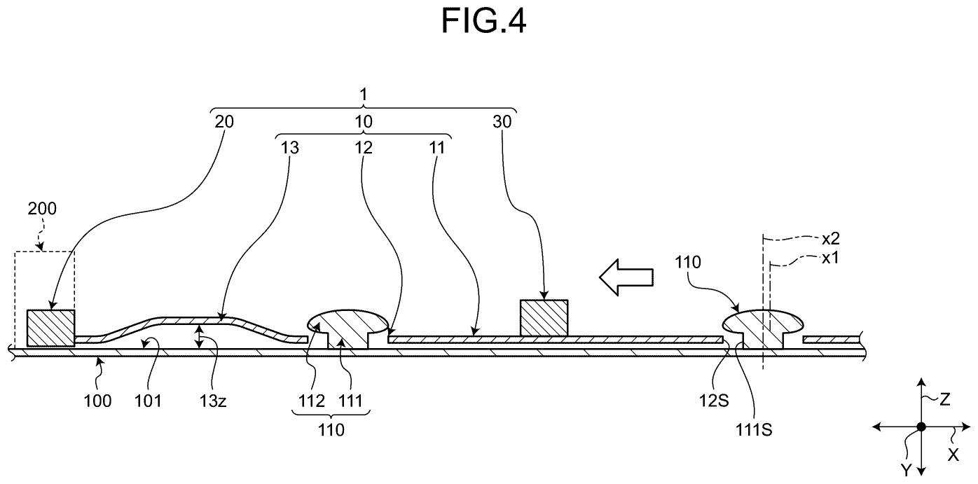

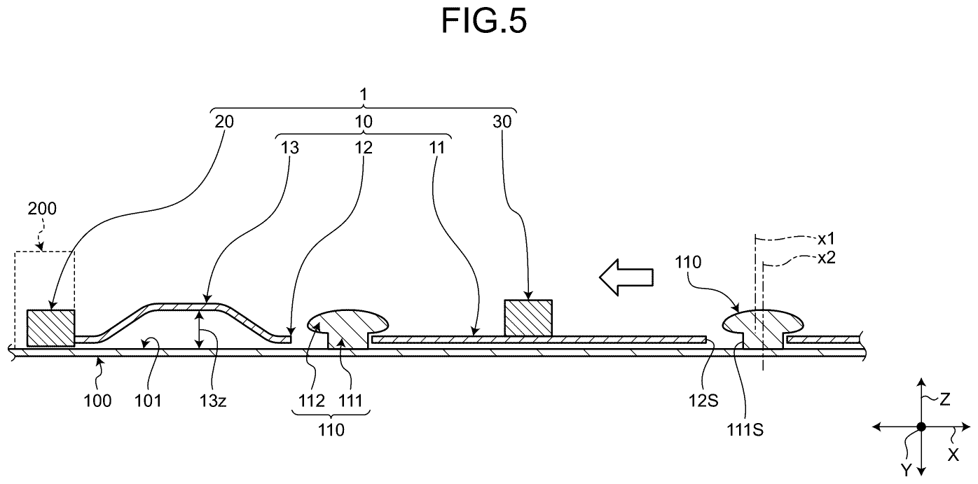

Specifically, as illustrated in FIGS. 3 to 5, the flat wiring member 10 can relatively move along the length direction X relative to the attachment target portion 100. For example, in a case where the inner circumferential surface 12S of the attachment hole portion 12 and the outer circumferential surface 111S of the shaft portion 111 of the attachment projection portion 110 have contact on the first connector 20 side (left side in FIG. 3), the flat wiring member 10 can relatively move toward the opposite side (right side in FIG. 3) of the first connector 20 side. Then, as illustrated in FIGS. 4 and 5, the flat wiring member 10 can relatively move until the inner circumferential surface 12S of the attachment hole portion 12 and the outer circumferential surface 111S of the shaft portion 111 of the attachment projection portion 110 have contact on the opposite side of the first connector 20 side.

Further, as illustrated in FIGS. 3 to 5, the looseness forming portion 13 of the flat wiring member 10 can adjust a looseness amount 13z (a warping mount of the looseness forming portion 13 with respect to the attachment target portion 100) in accordance with the movement of the flat wiring member 10. For example, in a case where the inner circumferential surface 12S of the attachment hole portion 12 and the outer circumferential surface 111S of the shaft portion 111 of the attachment projection portion 110 have contact on the first connector 20 side (refer to FIG. 3), the looseness amount 13z of the looseness forming portion 13 becomes the smallest, and an extra length of the flat wiring member 10 enters an absorbed state. Further, in a case where the inner circumferential surface 12S of the attachment hole portion 12 and the outer circumferential surface 111S of the shaft portion 111 of the attachment projection portion 110 do not have contact (refer to FIG. 4), by a center line x1 of the attachment hole portion 12 moving in a direction getting closer to a center line x2 of the shaft portion 111, the looseness amount 13z of the looseness forming portion 13 becomes larger than that in the configuration illustrated in FIG. 3. Further, in a case where the inner circumferential surface 12S of the attachment hole portion 12 and the outer circumferential surface 111S of the shaft portion 111 of the attachment projection portion 110 have contact on the opposite side of the first connector 20 side (refer to FIG. 5), by the center line x1 of the attachment hole portion 12 passing over the center line x2 of the shaft portion 111 and moving from the left side to the right side of the center line x2, the looseness amount 13z of the looseness forming portion 13 becomes the largest. Thus, the looseness forming portion 13 can prevent the flat wiring member 10 from being strongly-stretched without looseness when the flat wiring member 10 is relatively moved along the length direction X relative to the attachment target portion 100.

Further, if the flat wiring member 10 moves along the length direction X, the second connector 30 provided on the flat wiring member 10 relatively moves along the length direction X together with the flat wiring member 10. Thus, the operator can adjust the position of the second connector 30 in the length direction X.

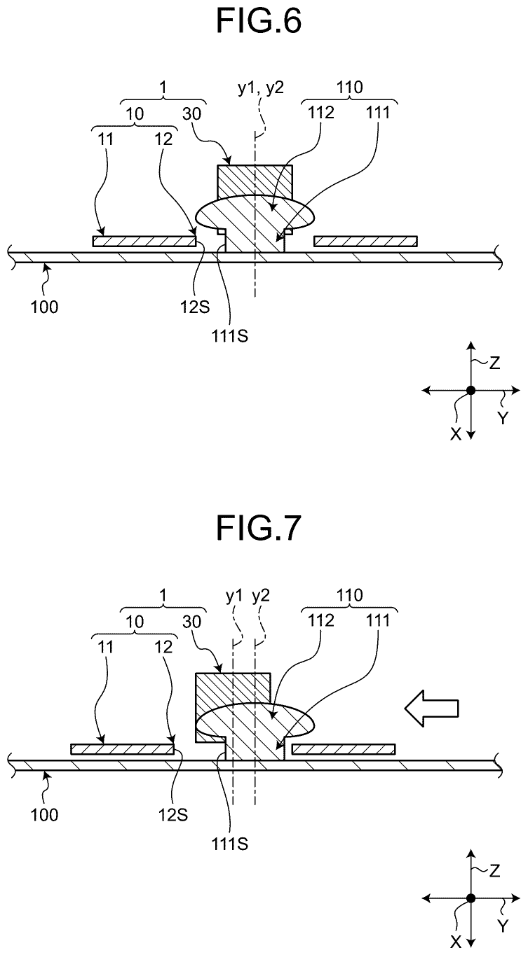

Further, as illustrated in FIGS. 6 and 7, the flat wiring member 10 can relatively move along the width direction Y relative to the attachment target portion 100. For example, in a case where the inner circumferential surface 12S of the attachment hole portion 12 and the outer circumferential surface 111S of the shaft portion 111 of the attachment projection portion 110 do not have contact, the flat wiring member 10 can relatively move until the inner circumferential surface 12S of the attachment hole portion 12 and the outer circumferential surface 111S of the shaft portion 111 of the attachment projection portion 110 have contact.

Further, if the flat wiring member 10 moves along the width direction Y, the second connector 30 provided on the flat wiring member 10 can relatively move along the width direction Y together with the flat wiring member 10. For example, as illustrated in FIG. 6, the second connector 30 of the present embodiment is provided in such a manner that its center overlaps the center of the flat wiring member 10. Thus, in a case where the inner circumferential surface 12S of the attachment hole portion 12 and the outer circumferential surface 111S of the shaft portion 111 of the attachment projection portion 110 do not have contact, and a center line y1 of the attachment hole portion 12 is positioned with overlapping a center line y2 of the shaft portion 111 (refer to FIG. 6), the center of the second connector 30 is positioned with overlapping the center of the shaft portion 111. Further, in contact, in a case where the inner circumferential surface 12S of the attachment hole portion 12 and the outer circumferential surface 111S of the shaft portion 111 of the attachment projection portion 110 do have contact, and the center line y1 of the attachment hole portion 12 is positioned with being shifted from the center line y2 of the shaft portion 111 (refer to FIG. 7), the center of the second connector 30 is positioned with being shifted from the center of the shaft portion 111. Thus, the operator can adjust the position of the second connector 30 in the width direction Y.

Accordingly, according to the above-described assembling operation of the wire harness 1, when the second connector 30 and the second connection target 300 fit with each other, by relatively moving the second connector 30 together with the flat wiring member 10, it is possible to adjust the position of the second connector 30 relative to the attachment target portion 100. Thus, the second connector 30 can be appropriately positioned with respect to the second connection target 300.

the above-described wire harness 1 includes the flat wiring member 10 having flexibility, the first connector 20 provided at the end portion 10a of the flat wiring member 10 and connected to the first connection target 200, and the second connector 30 provided on the surface 11 of the flat wiring member 10 and connected to the second connection target 300. Further, the flat wiring member 10 includes the attachment hole portion 12 formed at a position neighboring the second connector 30, into which the attachment projection portion 110 provided on the attachment target portion 100 is to be inserted, and the inner diameter 12r of the attachment hole portion 12 is set to a diameter larger than the outer diameter of the attachment projection portion 110.

With such a configuration, by forming the flat wiring member 10 in such a manner that the position of the flat wiring member 10 relative to the attachment target portion 100 can be adjusted, it is possible to appropriately connect the second connector 30 to the second connection target 300 of which the position relative to the attachment target portion 100 cannot be adjusted. Accordingly, the wire harness 1 can enhance ease of assembly. Further, by the wire harness 1 enhancing ease of assembly, a connection work (wire connection) between the second connector 30 and the second connection target 300 becomes easier. Accordingly, the wire harness 1 can also enhance workability.

Specifically, the flat wiring member 10 of the above-described wire harness 1 can be engaged with the engagement lug portion 112 (large diameter portion) in which the rim portion of the attachment hole portion 12 is formed on the leading end side of the attachment projection portion 110, in a state in which the attachment projection portion 110 is inserted in the attachment hole portion 12, and can relatively move along the planar direction of the flat wiring member 10 (the XY direction illustrated in FIG. 1) within the range within which the inner circumferential surface 12S of the attachment hole portion 12 and the outer circumferential surface 111S of the shaft portion 111 (small diameter portion) formed on the proximal end side of the attachment projection portion 110 have contact. With such a configuration, the wire harness 1 can adjust the position of the flat wiring member 10 relative to the attachment target portion 100 in the planar direction (in two directions of the length direction X and the width direction Y). Thus, the wire harness 1 can appropriately connect the second connector 30 to the second connection target 300. Accordingly, the wire harness 1 can enhance ease of assembly.

Here, the second connector 30 of the above-described wire harness 1 can fit with the second connection target 300 in accordance with fixing of the second connection target 300 to the attachment target portion 100, and can be positioned with respect to the second connection target 300 by relatively moving in the planar direction (the XY direction illustrated in FIG. 1) together with the flat wiring member 10. With such a configuration, the wire harness 1 can adjust the position of the second connector 30 relative to the attachment target portion 100 similarly to the flat wiring member 10. Thus, the wire harness 1 can enhance ease of assembly by appropriately positioning the second connector 30 with respect to the second connection target 300.

Furthermore, the flat wiring member 10 of the above-described wire harness 1 includes the looseness forming portion 13 that forms an extra length between the first connector 20 and the attachment hole portion 12 in a state in which the first connector 20 is connected to the first connection target 200 fixed to the attachment target portion 100, and the attachment projection portion 110 is inserted in the attachment hole portion 12. With such a configuration, the wire harness 1 can cause the looseness forming portion 13 to absorb a displacement caused by the relative movement, by increasing or decreasing the looseness amount 13z of the looseness forming portion 13 when the position of the flat wiring member 10 relative to the attachment target portion 100 is adjusted. Thus, by the looseness forming portion 13 being applied, the wire harness 1 can allow a displacement caused by the relative movement, and prevent the movement from being disturbed. Thus, the wire harness 1 can appropriately connect the second connector 30 to the second connection target 300, and enhance ease of assembly.

Furthermore, the pair of attachment hole portions 12 formed in the flat wiring member 10 of the above-described wire harness 1 is provided at an interval, and the second connector 30 is provided between the pair of attachment hole portions 12. With such a configuration, the wire harness 1 can adjust the position of the second connector 30 relative to the attachment target portion 100 on both sides of the second connector 30. Thus, the wire harness 1 can enhance ease of assembly by more appropriately positioning the second connector 30 with respect to the second connection target 300.

In addition, the above-described wire harness 1 according to an embodiment of the present invention is not limited to the above-described embodiment, and various changes can be made within the scope set forth in the appended claims.

For example, the flat wiring member 10 has been described as an FPC, but the flat wiring member 10 may be a flexible flat cable (FFC), and the configuration thereof is not specifically limited as long as the flat wiring member 10 is a flat wiring member having flexibility.

Further, it has been described that a pair of attachment hole portions 12 is provided, but the number of attachment hole portions 12 is not specifically limited. For example, only one attachment hole portion 12 may be provided, and its position may be whichever of the first connector 20 side with respect to the second connector 30, or the opposite side of the first connector 20.

Further, the wire harness 1 according to the present embodiment may be formed by appropriately combining the components of the above-described embodiment.

The wire harness according to the present embodiment produces an effect that ease of assembly can be enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a flat wiring member having flexibility;
a first connector provided at an end portion of the flat wiring member and connected to a first connection target; and
a second connector provided on a surface of the flat wiring member and connected to a second connection target, wherein
the flat wiring member includes an attachment hole portion formed at a position neighboring the second connector, into which an attachment projection portion provided on an attachment target portion is to be inserted, and
an inner diameter of the attachment hole portion is set to a diameter larger than an outer diameter of the attachment projection portion.

2. The wire harness according to claim 1, wherein
the flat wiring member can be engaged with a large diameter portion in which a rim portion of the attachment hole portion is formed on a leading end side of the attachment projection portion, in a state in which the attachment projection portion is inserted in the attachment hole portion, and can relatively move along a planar direction of the flat wiring member within a range within which an inner circumferential surface of the attachment hole portion and an outer circumferential surface of a small diameter portion formed on a proximal end side of the attachment projection portion have contact.

3. The wire harness according to claim 1, wherein
the second connector can fit with the second connection target in accordance with fixing of the second connection target to the attachment target portion, and can be positioned with respect to the second connection target by relatively moving along a planar direction of the flat wiring member together with the flat wiring member.

4. The wire harness according to claim 2, wherein
the second connector can fit with the second connection target in accordance with fixing of the second connection target to the attachment target portion, and can be positioned with respect to the second connection target by relatively moving along a planar direction of the flat wiring member together with the flat wiring member.

5. The wire harness according to claim 1, wherein
the flat wiring member includes a looseness forming portion that forms an extra length between the first connector and the attachment hole portion in a state in which the first connector is connected to the first connection target fixed to the attachment target portion, and the attachment projection portion is inserted in the attachment hole portion.

6. The wire harness according to claim 2, wherein
the flat wiring member includes a looseness forming portion that forms an extra length between the first connector and the attachment hole portion in a state in which the first connector is connected to the first connection target fixed to the attachment target portion, and the attachment projection portion is inserted in the attachment hole portion.

7. The wire harness according to claim 1, wherein
a pair of the attachment hole portions is provided at an interval, and
the second connector is provided between a pair of the attachment hole portions.

8. The wire harness according to claim 2, wherein
a pair of the attachment hole portions is provided at an interval, and
the second connector is provided between a pair of the attachment hole portions.
